(19) United States
(12) Patent Application Publication
(10) Pub. No.: US 2001/0032079 A1
(43) Pub. Date: Oct. 18, 2001

(54) Speech signal processing apparatus and method, and storage medium

(76) Inventors: Yasuo Okutani, Kanagawa (JP); Yasuhiro Komori, Kanagawa (JP)

Correspondence Address: FITZPATRICK CELLA HARPER & SCINTO, 30 ROCKEFELLER PLAZA, NEW YORK, NY, 10112, US

(21) Appl. No.: 09/818,607

(22) Filed: Mar. 28, 2001

(30) Foreign Application Priority Data
Mar. 31, 2000 (JP) 2000-099533

(51) Int. Cl. G10L 13/00

(52) U.S. Cl. 704/258

(57) ABSTRACT

An object of the present invention is to suppress degradation of the quality in speech synthesis by selecting synthesis units so as to minimize a distortion caused by concatenation distortions and modification distortions. For that purpose, speech synthesis is performed by extracting a plurality of synthesis units corresponding to a phoneme environment from a synthesis-unit holding unit for holding a plurality of synthesis units so as to correspond to a predetermined prosody environment, calculating a distortion of each of the plurality of extracted synthesis units, obtaining a minimum distortion within a predetermined interval determined based on the prosody environment, selecting a series of synthesis units providing a minimum-distortion path, and modifying and concatenating the synthesis units.

### BACKGROUND OF THE INVENTION

1. Field of the Invention

The present invention relates to a speech signal processing apparatus and method for performing speech synthesis by editing and connecting phonemes, and a storage medium storing a program for realizing the method.

2. Description of the Related Art

Recently, speech synthesis apparatuses are known in which speech synthesis is performed by inputting text data, generating prosody parameters while generating silent positions, the lengths of silent times, accents and the like by performing language analysis of the text data, retrieving a synthesis units inventory storing synthesis units in accordance with the prosody parameters.

Such speech synthesis apparatuses mainly adopt a PSOLA (pitch-synchronous overlap-add) method in which the retrieved units are modified by copying or deleting each pitch waveforms consisting of the units, and concatenated each other.

A synthesized speech obtained by utilizing the above-described technique includes a distortion caused by modifying units (hereinafter termed a “modification distortion”), and a distortion caused by concatenating phonemes (hereinafter termed a “concatenation distortion”). These two types of distortions are large factors to cause degradation in the quality of the synthesized speech.

### SUMMARY OF THE INVENTION

The present invention has been made in consideration of the above-described problems.

It is an object of the present invention to provide a speech signal processing apparatus and method for minimizing the influence of distortions due to connection and deformation, and a storage medium storing a program for realizing the method.

According to one aspect, the present invention which achieves the above-described object relates to a speech signal processing apparatus for performing speech synthesis by concatenating a plurality of selected units and modifying the units based on predetermined prosody information. The apparatus includes distortion obtaining means for obtaining a distortion which may be generated from selection to synthesis of the phonemes, selection means for selecting units to be used for speech synthesis, based on the distortion obtained by said distortion obtaining means, and speech synthesis means for performing speech synthesis based on the units selected by the selection means.

According to another aspect, the present invention which achieves the above-described object relates to a speech signal processing method including a distortion obtaining step of obtaining a distortion generated by concatenating a plurality of selected synthesis units and modifying the synthesis units based on predetermined prosody parameters, a selection step of selecting synthesis units to be used for speech synthesis, based on the distortion obtained in said distortion obtaining step, and a speech synthesis step of performing speech synthesis based on the synthesis units selected in the selection step.

The foregoing and other objects, advantages and features of the present invention will become more apparent from the following description of the preferred embodiments taken in conjunction with the accompanying drawings.

### BRIEF DESCRIPTION OF THE DRAWINGS

FIG. 1 is a block diagram illustrating the configuration of hardware of a speech synthesis apparatus according to a first embodiment of the present invention;

FIG. 2 is a block diagram illustrating the configuration of a speech synthesis unit shown in FIG. 1;

FIG. 3 is a flowchart illustrating speech synthesis processing in the speech synthesis unit shown in FIG. 2;

FIG. 4 is a flowchart illustrating the detail of unit selection processing in step S304 shown in FIG. 3;

FIG. 5 is a schematic diagram illustrating calculation of the sum Sn,1 of minimum distortions for a synthesis-unit candidate Pn,1 of an n-th phoneme;

FIG. 6 is a diagram illustrating a concatenation distortion of units in the first embodiment;

FIG. 7 is a diagram illustrating a modification distortion of a unit according to the first embodiment;

FIG. 8 is a schematic diagram illustrating a half-diphone as a synthesis unit according to a second embodiment of the present invention;

FIG. 9 is a diagram illustrating a case in which synthesis units are represented by mixture of a diphone and half-diphones, according to a third embodiment of the present invention;

FIG. 10 is a diagram illustrating a case in which synthesis units are represented by diphones, each configured by half-diphones, according to a fourth embodiment of the present invention;

FIG. 11 is a diagram illustrating the configuration of a table for determining a concatenation distortion between a diphone/a.r/and a diphone/r.i/, according to a twelfth embodiment of the present invention;

FIG. 12 is a diagram illustrating a table showing modification distortions, according to a thirteenth embodiment of the present invention; and

FIG. 13 is a diagram illustrating a specific example of estimating a modification distortion, according to the thirteenth embodiment.

### DESCRIPTION OF THE PREFERRED EMBODIMENTS

Preferred embodiments of the present invention will now be described in detail with reference to the drawings.

First Embodiment

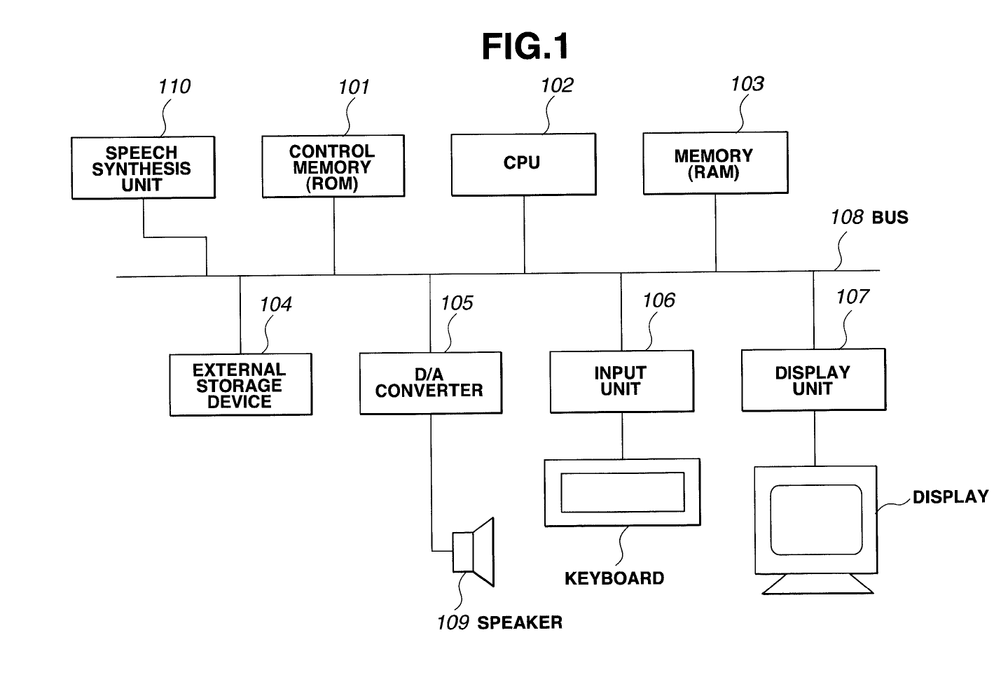

FIG. 1 is a block diagram illustrating the configuration of hardware of a speech synthesis apparatus according to a first embodiment of the present invention. Although in the first embodiment, a case of using an ordinary personal computer as the speech synthesis apparatus will be described, the present invention may be applied to a dedicated speech synthesis apparatus, or any other appropriate apparatus.

In FIG. 1, a control memory (ROM (read-only memory)) 101 stores various control data to be used in a central processing unit (CPU) 102. The CPU 102 controls the operations of the entire apparatus by executing control programs stored in a memory (RAM (random access memory)) 103. The RAM 103 is used as working areas for temporarily storing various data during execution of various control processes by the CPU 102, and loads and stores a control program from an external storage device 104 during execution of each processing by the CPU 102. The external storage device 104 uses, for example, a hard disk, a CD(compact disc)-ROM, an FD (floppy disk), an optical disk or the like. When digital data representing a voice signal is input, a D/A (digital-to-analog) converter 105 converts the input signal into an analog signal, and outputs the analog signal to a speaker 109, which reproduces voice. An input unit 106 includes input means, for example, a keyboard, a pointing device such as a mouse, and the like which are operated by the user. A text, serving as an origin of a synthesized speech by a speech synthesis unit 110, is input from the input unit 106. The input unit 106 may be a keyboard for inputting a text in the form of codes, or input means, having an OCR (optical character recognition) function, for converting image information read by image reading means, such as a scanner, a camera or the like, into codes by performing character recognition. If the input means has a voice receiving function and a voice recognition function, it is also possible to input a text by a voice. Furthermore, the function of the input unit 106 may be provided by an apparatus connected to this apparatus via a network. In this case, the input unit 106 may be included within the apparatus connected via the network. Alternatively, only the above-described image reading means, or voice receiving means having a function of receiving a voice is included in the apparatus connected via the network, and image data or voice data may be converted into a text by a character recognition function or a voice recognition function of the speech synthesis apparatus, respectively, after being input to the speech synthesis apparatus via the network. A display unit 107 includes a display, such as a CRT (cathode-ray tube), a liquid-crystal display or the like. A bus 108 interconnects these units. Reference numeral 110 represents a speech synthesis unit.

A control program for making the CPU 102 act as the speech synthesis unit 110 may be loaded from the external storage device 104 and stored into the RAM 103, and various data used in the control program are stored in the control memory 101. Data from among the various data is appropriately taken into the RAM 103 via the bus 108 under the control of the CPU 102, and are used in control processing by the CPU 102. Then the CPU 102 and RAM 103 work as the speech synthesis unit 110. The external storage device 104 may be a storage device capable of exchanging data via a network, such as the Internet, a LAN (local area network) or the like.

The D/A converter 105 converts speech-waveform data (a digital signal) formed by executing the control program into an analog signal, and outputs the analog signal to the speaker 109. Even if the speaker 109 is not provided in the main body of the apparatus, it is also possible to output the analog signal from a speaker of another apparatus via a network. In this case, an analog signal obtained by converting a digital signal by the D/A converter 105 may be output to another terminal via the network. Alternatively, it is, of course, possible to output a digital signal to another terminal via a network, converted the digital signal into an analog signal at the terminal, and output the analog signal. Particularly when outputting an analog signal, a terminal where the analog signal is output via a network may include only a speaker. Hence, the terminal is not limited to a computer, but may be a telephone set, a portable terminal or an audio apparatus. Even such a terminal can deal with a case of receiving a digital signal if a D/A converter is included.

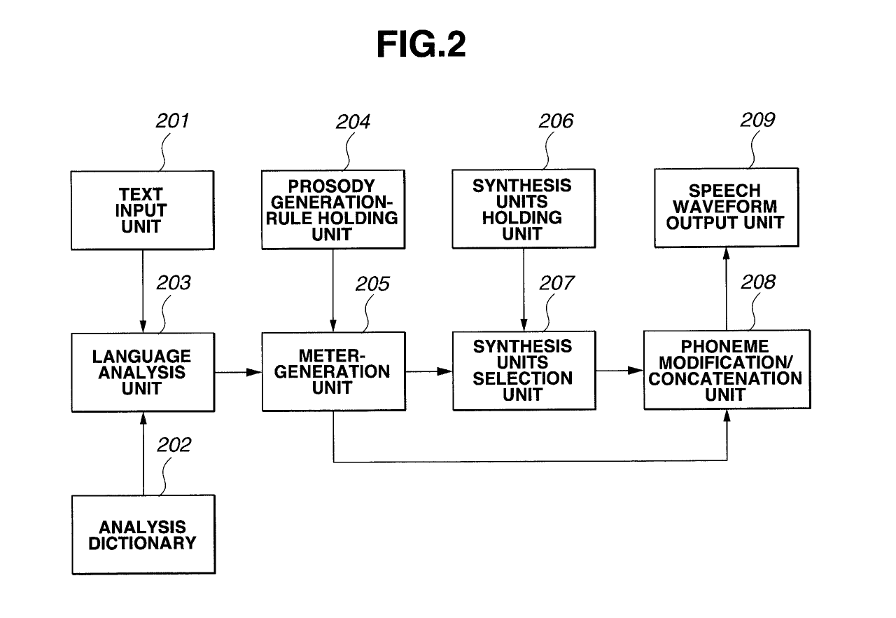

FIG. 2 is a block diagram illustrating the configuration of the speech synthesis unit 110 shown in FIG. 1.

In FIG. 2, a text input unit 201 inputs arbitrary text data from the input unit 106 or the external storage device 104. There are also shown an analysis dictionary 202, a language analysis unit 203, a prosody-generation-rule holding unit 204, a prosody generation unit 205, a synthesis-unit holding unit 206, serving as a synthesis units inventory, a synthesis-unit selection unit 207, a synthesis-unit modification/concatenation unit 208, and a speech-waveform output unit 209.

In the above-described configuration, the language analysis unit 203 performs language analysis of a text input from the text input unit 201 by referring to the analysis dictionary 202. The result of the analysis is input to the prosody generation unit 205. The prosody generation unit 205 generates a phoneme series and prosody parameters based on information relating to a prosody generation rule held in the prosody-generation-rule holding unit 204, and outputs the generated data to the synthesis-unit selection unit 207 and the synthesis-unit modification/concatenation unit 208. Then, the synthesis-unit selection unit 207 selects corresponding units from among synthesis units held in the synthesis-unit holding unit 206, using the result of prosody generation input from the prosody generation unit 205. The synthesis-unit holding unit 206 holds in advance a plurality of synthesis units corresponding to a plurality of phoneme environments, and selects and outputs a plurality of synthesis units which are considered to be able to be used for a synthesized speech in accordance with an instruction from the synthesis-unit selection unit 207. The synthesis-unit modification/concatenation unit 208 generates a speech waveform by modifying and concatenating the synthesis units output from the synthesis-unit selection unit 207, in accordance with the result of prosody generation input from the prosody generation unit 205. The generated speech waveform is output from the speech-waveform output unit 209.

Next, speech synthesis processing according to the first embodiment having the above-described configuration will be described.

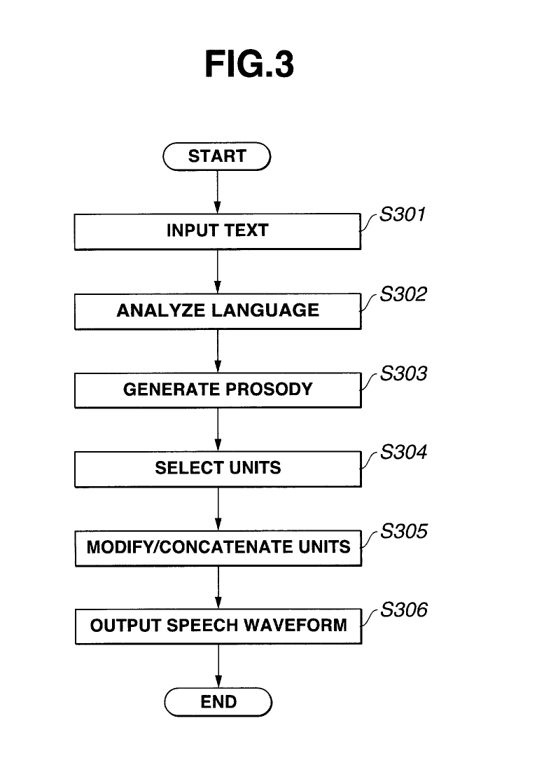

FIG. 3 is a flowchart illustrating the flow of speech synthesis processing in the speech synthesis unit 110 of the first embodiment.

First, in step S301, the text input unit 201 inputs text data in units of a sentence, a clause, a word or the like. The process then proceeds to step S302. In step S302, the language analysis unit 203 performs language analysis of the text data. The process then proceeds to step S303, where the prosody generation unit 205 generates a phoneme series and prosody parameters based on the result of the analysis in step S302 and a predetermined prosody rule. The process then proceeds to step S304, where the synthesis-unit selection unit 207 selects, for each phoneme, synthesis units registered in the synthesis-unit holding unit 206, based on the prosody parameters obtained in step S303 and a predetermined phoneme environment. The process then proceeds to step S305, where the synthesis-unit modification/concatenation unit 208 modifies and concatenates the synthesis units, based on the selected synthesis units and the prosody parameters generated in step S303. The process then proceeds to step S306, where the speech-waveform output unit 209 outputs the speech waveform generated by the synthesis-unit modification/concatenation unit 208, as a speech signal. Thus, a speech corresponding to the input text is output.

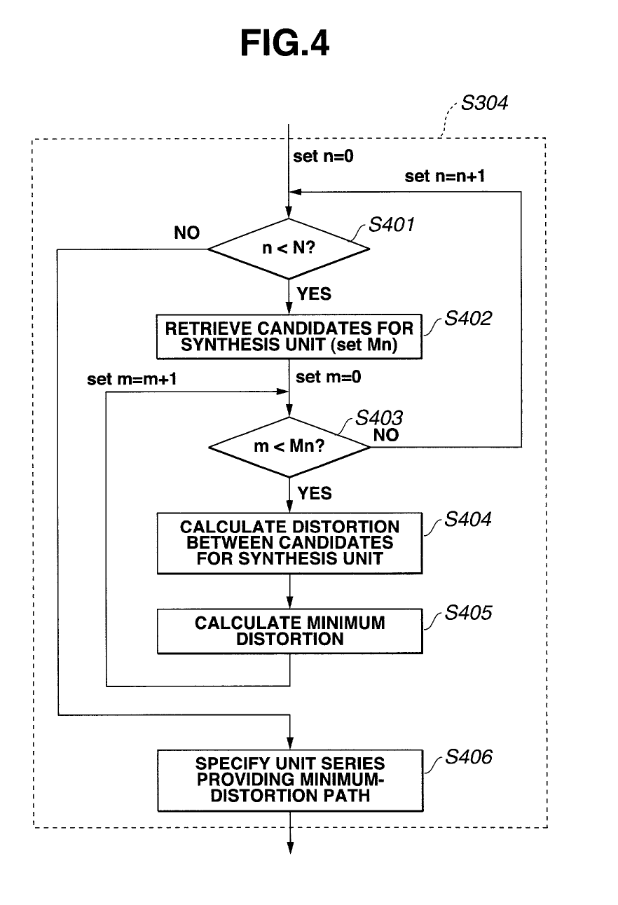

FIG. 4 is a flowchart illustrating the details of the processing of step S304 (synthesis-unit selection) shown in FIG. 3.

In this step S304, a synthesis-unit series having a minimum distortion value for the entirety of the input text data is determined using dynamic programming, in accordance with a distortion value (to be described later) determined based on a concatenation distortion between synthesis units (to be described later) and a modification distortion of a synthesis unit (to be described later). That is, processing is sequentially performed from the head (n=0) of phoneme series Pn (0≦n<N) generated by the prosody generation unit 205. First, n=0 is set. When the processing is not yet terminated to the end of the phoneme series as a result of determination in step S401, i.e., when n<N, the process proceeds to step S402, where a plurality of synthesis-unit candidates in the n-th phoneme are taken from the synthesis-unit holding unit 206 and stored into the RAM 103 making the number of synthesis-unit candidates Mn. The process then proceeds to step S403 after setting m=0. In step S403, all of a plurality of candidates are sequentially processed starting from the head (m=0) of synthesis-unit candidates in the n-th phoneme, for synthesis-unit candidates Pn,m (0≦m<Mn) specified by n and m. When the processing is not yet terminated to the last of the candidates by processing of comparing the value “m” and the value “Mn” in step S403, i.e., when it is determined that m<Mn, the process proceeds to step S404. When the calculation of the concatenation distortion of each candidate and the calculation of the minimum distortion to the concerned phoneme have been completed to the last candidate, i.e., when it is determined that m<Mn is not satisfied, a value 1 is added to the value “n” in order to move to processing for the next phoneme, and the process returns to step S401. In step S404, each distortion value Dk,m between each synthesis-unit candidate Pn−1,k (0≦k<Mn−1, where Mn−1 is the number of synthesis-unit candidates for the immediately preceding phoneme Pn−1) of the immediately preceding “(n−1)”-th phoneme and the candidate Pn,m (i.e., a concatenation distortion between the k-th synthesis-unit candidate of the (n−1)-th phoneme and the m-th synthesis-unit candidate of the “n”-th phoneme) is calculated for all candidates. The process then proceeds to step S405, where a sum Sn,m, which is a minimum value of the sum of distortion values to the candidate Pn,m, is obtained. The sum Sn,m is expressed by the following equation:

Sn,m=min(Sn−1,k+Dk,m),

where 0≦k<Mn−1.

In this equation, min( ) indicates a minimum value when k is changed from “0” to “Mn−1”, and is obtained in performing calculation for the “m”-th synthesis unit of the “n”-th phoneme, the concatenation distortion between the synthesis unit and the “m”-th synthesis unit of the “n”-th phoneme is calculated, and the concatenation distortion and modification distortion of the “m”-th synthesis unit of the “n”-th phoneme is added to the accumulated distortion of the “k”-th synthesis unit of the “n−1”-th phoneme.

Then the minimum value of the calculated sums of distortion value is obtained. The value “k” indicating the candidate having the minimum value is held as PREn,m.

The PREn,m becomes address information for indicating a path for minimizing the sums of distortion values to the candidate Pn,m, and is utilized for specifying a minimum-distortion path in step S406. After determining the sum Sn,m and the PREn,m of the candidate Pn,m, a value 1 is added to the value “m” in order to perform processing for the next synthesis-unit candidate, and the process returns to step S403.

If the result of the determination in step S401 is negative, i.e., if it is determined that the processing has been completed to the n-th phoneme, which is the last phoneme of the given phoneme series, the process proceeds to step S406, where a candidate PN−1,m where the sum of distortion values SN−1,m (0≦m<Mn) has a minimum value is specified, and a synthesis-unit series providing a minimum-distortion path is specified by sequentially tracking PREn,m from that candidate. When the synthesis-unit series has been thus specified, the process proceeds to step S305 shown in FIG. 3 where modification/concatenation of the specified synthesis units are executed.

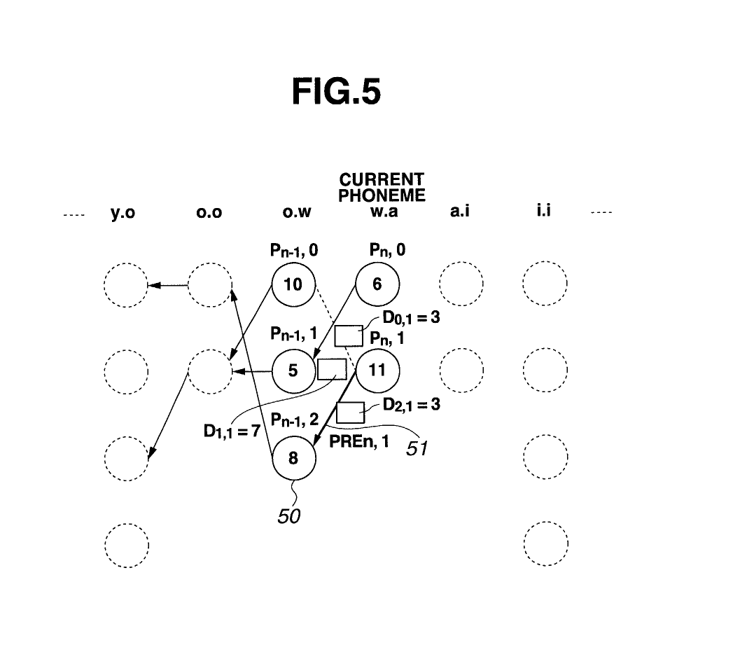

FIG. 5 is a schematic diagram illustrating calculation of the sum Sn,1 in synthesis-unit candidates Pn,1 of the n-th phoneme (the currently noticed phoneme). In the first embodiment, a case of adopting a diphone as a unit of phonemes will be described.

In FIG. 5, one circle indicates one synthesis-unit candidate Pn,m, and a numeral within the circle indicates a sum Sn,m, serving as a minimum value of the sums of distortion values. An arrow indicates the above-described PREn,m. A numeral surrounded by a square represents a distortion value Dk,m of a synthesis-unit candidate Pn,m.

Next, a distortion value in the first embodiment will be described.

In the first embodiment, a distortion value Dk,m is defined as a weighted sum of a concatenation distortion Dc and a modification distortion Dm. That is,

D=w×Dc+(1−w)×Dm,

where 0≦w≦1.

In this equation, a weighting coefficient w is empirically obtained by an preliminary experiment or the like. In the case of w=0, distortion values are described only by modification distortions Dm. In the case of w=1, distortion values depend only on concatenation distortions Dc.

In FIG. 5, a distortion value D2,1 between a phoneme candidate Pn,1 and a synthesis-unit candidate Pn−1,2 of the immediately preceding phoneme (a circle represented by numeral 50) is “3”, and a sum Sn−1,2 of distortion values to the synthesis-unit candidate Pn−1,2 (reference numeral 50) is “8”. Hence, a path 51 is determined as PREn,1.

Pn−1,0+D0,1=10+3=13

Pn−1,1+D1,1=5+7=12

Pn−1,2+D2,1=8+3=11<---minimum

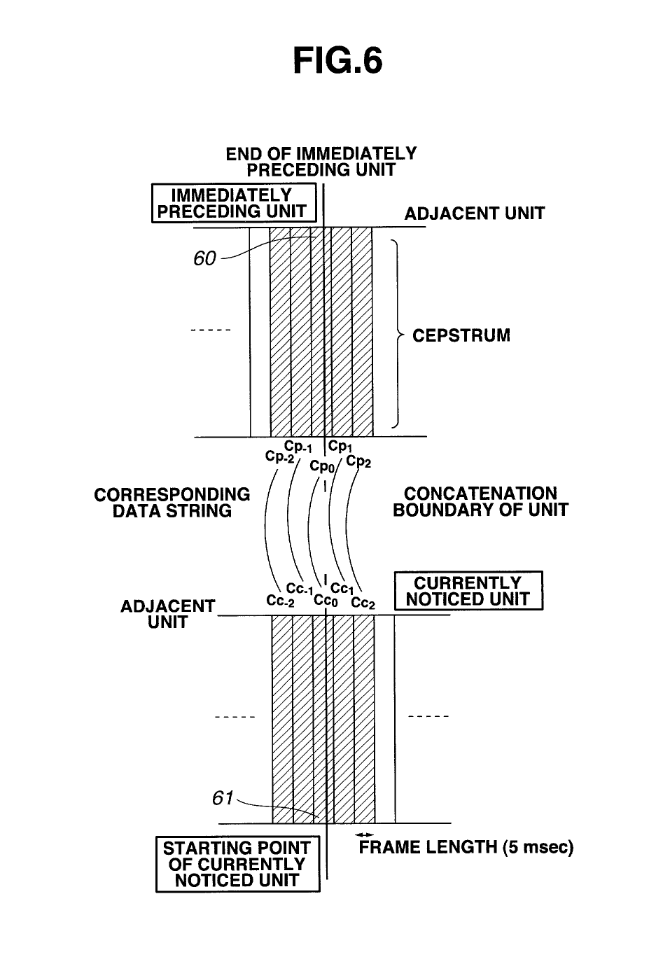

FIG. 6 is a diagram illustrating how to obtain a connection distortion Dc in the first embodiment.

A concatenation distortion Dc is a distortion generated at a concatenation portion between the immediately preceding synthesis unit and the current synthesis unit. In the first embodiment, Dc is represented using a cepstrum distance. In this case, concatenation distortions are calculated for 5 frames in total, i.e., each of frames 60 and 61 (a frame length of 5 milliseconds, and an analysis-window width of 25.6 milliseconds) where a boundary between synthesis units is present, and respective two preceding and succeeding frames. It is assumed that cepstrum has 17 dimensions in total, from 0-th degree (power) to 16th degree. The sum of the absolute values of differences between respective elements of the cepstrum vector is made a concatenation distortion in the currently noticed synthesis unit. When each element of the cepstrum vector at the end of the immediately preceding synthesis unit is represented by Cp i,j (i is the number of a frame, i=0 being a frame where a boundary between synthesis units is present, and j represents the index number of an element of the vector), and each element of the cepstrum vector at the starting point of the concerned synthesis unit is represented by Cc i,j, the concatenation distortion Dc of the currently noticed synthesis unit is represented by:

$$Dc = {\sum }_{i} {\sum }_{j} \vert Cp i , j - Cc i , j \vert ,$$

where the first Σ indicates the sum of the case in which i changes from—2 to 2, and the second Σ indicates the sum of the case in which j changes from 0 to 16.

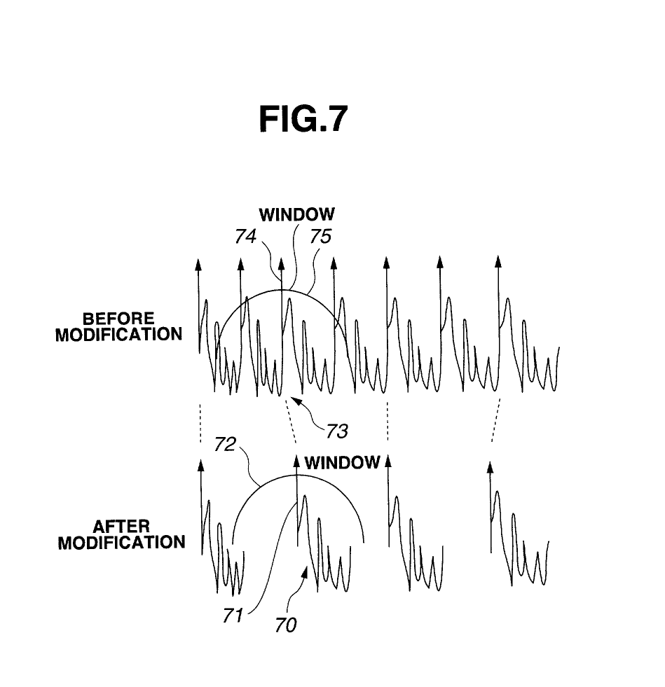

FIG. 7 is a diagram illustrating how to obtain a modification distortion Dm according to the first embodiment.

FIG. 7 illustrates a case of widening the pitch interval according to the PSOLA. In FIG. 7, an arrow indicates a pitch mark, and a broken line indicates correspondence between a pitch waveform unit before modification and the pitch waveform unit after modification. In the first embodiment, a modification distortion is represented based on the cepstrum distance between a pitch waveform unit before modification and the pitch waveform unit after modification. More specifically, first, by operating a Hanning window 72 (a window length of 25.6 milliseconds) around a pitch mark 71 of a certain pitch waveform unit (for example, indicated by numeral 70) after modification, the pitch waveform unit 70 is segmented together with surrounding pitch waveform units. The segmented pitch waveform unit 70 is subjected to cepstrum analysis. Then, a cepstrum is obtained in the same manner as in the case after modification, by segmenting pitch waveform units around a pitch mark 74 of a pitch waveform unit 73 before modification which corresponds to the pitch mark 71 using a Hanning window 75 having the same window length. The distance between the cepstrums thus obtained is made a modification distortion of the currently noticed pitch waveform unit 70, and a value obtained by dividing the sum of each modification distortion between a pitch waveform unit after modification and a corresponding pitch waveform unit before modification by the number Np of pitch waveform units adopted in the PSOLA is made a modification distortion of the concerned synthesis unit. The modification distortion thus obtained is expressed by the following equation:

$$Dm = {\sum }_{i} {\sum }_{j} \vert Corg i , j - Ctar i , j \vert / Np ,$$

where the first Σ indicates the sum of the case in which i changes from 1 to N, and the second Σ indicates the sum of the case in which j changes from 0 to 16. Ctar i,j indicates the j-th order element of the cepstrum of the i-th pitch waveform unit after modification, and Corg i,j indicates the j-th order element of the cepstrum of the corresponding pitch waveform unit before modulation.

As described above, according to the first embodiment, by performing speech synthesis by obtaining a concatenation distortion and a modulation distortion for each synthesis unit, obtaining a distortion value of each synthesis unit by performing weighting calculation based on the obtained distortions, and specifying a synthesis-unit series having a minimum sum of distortion values, it is possible to obtain an excellent result of speech synthesis.

Second Embodiment

Although in the first embodiment, the case of using a diphone as a synthesis unit, the present invention is not limited to such an approach. For example, a phoneme or a half-diphone may be adopted as a synthesis unit. The half-diphone is obtained by dividing a diphone into two portions at a border of phonemes.

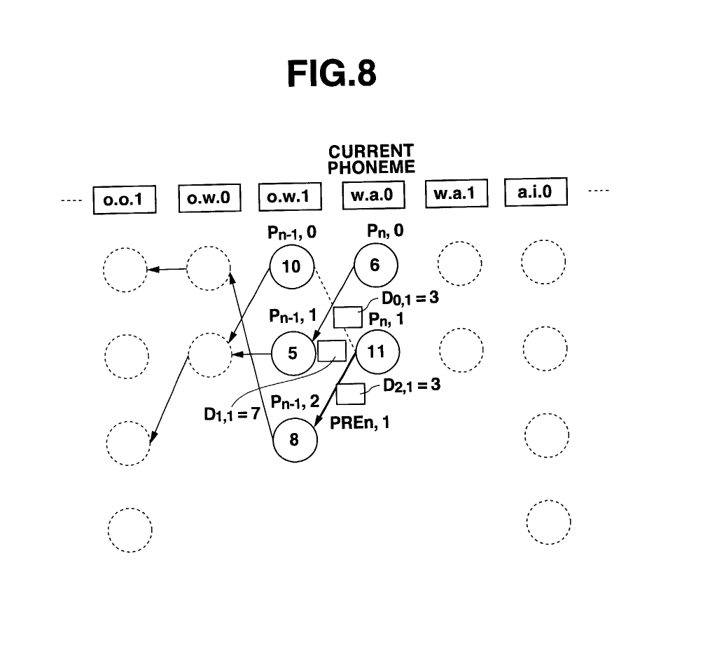

FIG. 8 is a schematic diagram when the half-diphone is used as a unit. Merits in such an approach will now be briefly described. When synthesizing an arbitrary text, a synthesis units inventory must prepare all types of diphones. On the other hand, when using the half-diphone as a unit, a half-diphone which lacks can be substituted by another half-diphone. For example, even if “/a.n.0/” is used instead of “/a.b.0/(the left side of a diphone a.b)”, a voice can be excellently reproduced with less degradation of quality. Hence, the size of the synthesis units inventory can be reduced.

Third Embodiment

Although in the foregoing first and second embodiments, the cases of using a diphone, and a phoneme or a half-diphone, respectively, have been described, the present invention is not limited to such approaches, but these units may be mixed. For example, a diphone may be used as the unit for a phoneme having a high frequency of utilization, and two half-diphones may be used for a phoneme having a low frequency of utilization.

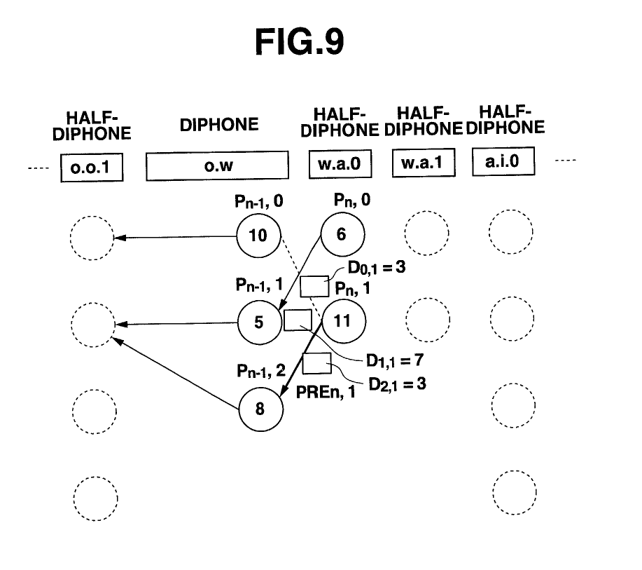

FIG. 9 is a diagram illustrating a case in which different phoneme units are mixed. In this case, a phoneme “o.w” is represented by diphones, and a phoneme before or after this phoneme is represented by half-diphones.

Fourth Embodiment

In the third embodiment, information relating to whether or not a pair of half-diphones are taken from consecutive portions in the original database may be provided, and if the pair of half-diphones are taken from consecutive portions, the pair of half-diphones may be virtually dealt with as a diphone. That is, when a pair of half-diphones are consecutive in the original database, a concatenation distortion is “0”. Hence, in this case, it is only necessary to consider a modification distortion, and it is possible to greatly reduce the amount of calculation.

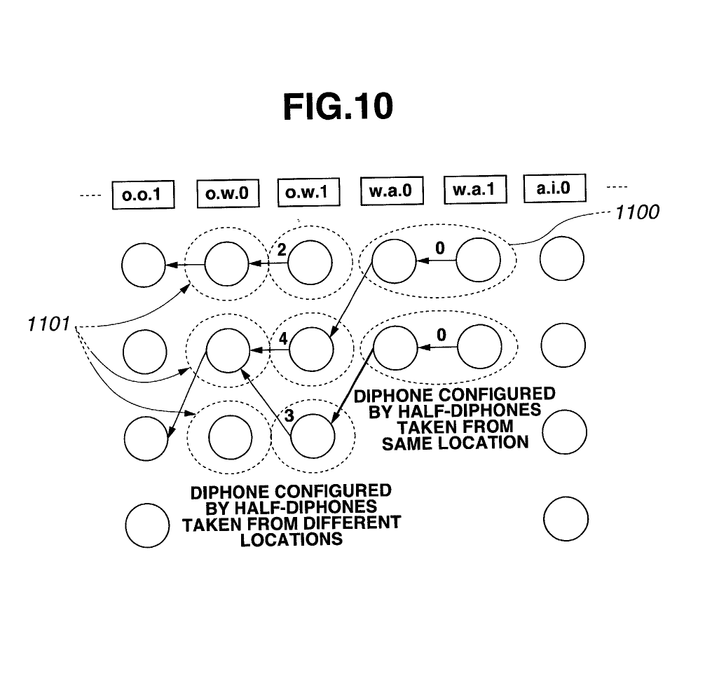

FIG. 10 is a schematic diagram illustrating such a case. In FIG. 10, a numeral on each line indicates a concatenation distortion.

In FIG. 10, a pair of half-diphones indicated by 1100 are taken from consecutive portions in the original database, and the concatenation distortion for this pair is uniquely determined to be “0”. Since a pair of half-diphones indicated by 1101 are not taken from consecutive portions in the original database, a concatenation distortion is calculated for each of the pair.

Fifth Embodiment

Although in the first embodiment, the case of applying dynamic programming to the entirety of a phoneme series obtained from a unit of text data has been described, the present invention is not limited to such a case. For example, a phoneme series may be divided by dealing with even a pause or a silent portion as an interval, and dynamic programming may be executed for each interval. The silent portion in this case indicates a silent portion such as p, t or k. Since a concatenation distortion is considered to be “0” at such a pause or silent portion, such division is effective. It is thereby possible to obtain an appropriate result of selection for each interval, and shorten the time required for generating a synthesized speech.

Sixth Embodiment

Although in the first embodiment, the case of using cepstrum for calculating a concatenation distortion, the present invention is not limited to such an approach. For example, a concatenation distortion may be obtained using the sum of differences between waveforms before and after a concatenation point. Alternatively, a concatenation distortion may be obtained using, for example, a spectrum distance. In this case, a concatenation point is preferably synchronized with a pitch mark.

Seventh Embodiment

Although in the first embodiment, the window length, the frame shift length, the order of a cepstrum, the number of frames, and the like have been described using specific numerals in the calculation of a concatenation distortion, the present invention is not limited to such an approach. A concatenation distortion may be calculated using an arbitrary window length, frame shift length, order, and number of frames.

Eighth Embodiment

Although in the first embodiment, the case of using the sum of differences for each order of cepstrum for calculation of a concatenation distortion, the present invention is not limited to such an approach. For example, each order may be normalized (normalization coefficient rj) using statistical properties or the like. In this case, a concatenation distortion Dc is expressed by:

Dc=ΣΣ(rj×|Cprei,j−Ccur i,j|),

where the first Σ indicates the sum of the case in which i changes from—2 to 2, and the second Σ indicates the sum of the case in which j changes from 0 to 16.

Ninth Embodiment

Although in the first embodiment, the case of calculating a concatenation distortion based on the absolute value of a difference for each order of cepstrum has been described, the present invention is not limited to such an approach. For example, a concatenation distortion may be calculated based on the power of the absolute value (not necessarily the absolute value when the number of power is even) of a difference. When the number of power is represented by N, a concatenation distortion Dc is expressed by:

Dc=ΣΣ|Cprei,j−Ccuri,j|ˆ N,

where “ˆ N” indicates the n-th power. An increase of the value N indicates sensibility for a large difference. As a result, a concatenation distortion is reduced on average.

Tenth Embodiment

Although in the first embodiment, the case of using cepstrum as a modification distortion has been described, the present invention is not limited to such an approach. For example, a modification distortion may be obtained using the sum of differences between waveforms in a constant interval before and after modification. Alternatively, a spectrum distance may be used as a modification distortion.

Eleventh Embodiment

Although in the first embodiment, the case of calculating a modification distortion based on information obtained from a waveform has been described, the present invention is not limited to such an approach. For example, A modification distortion may be calculated based on the number of operations of deleting and copying a pitch waveform unit when performing a PSOLA operation.

Twelfth Embodiment

Although in the first embodiment, the case of calculating a concatenation distortion every time a synthesis unit is read during speech synthesis has been described, the present invention is not limited to such an approach. For example, concatenation distortions may be calculated in advance and stored in a table.

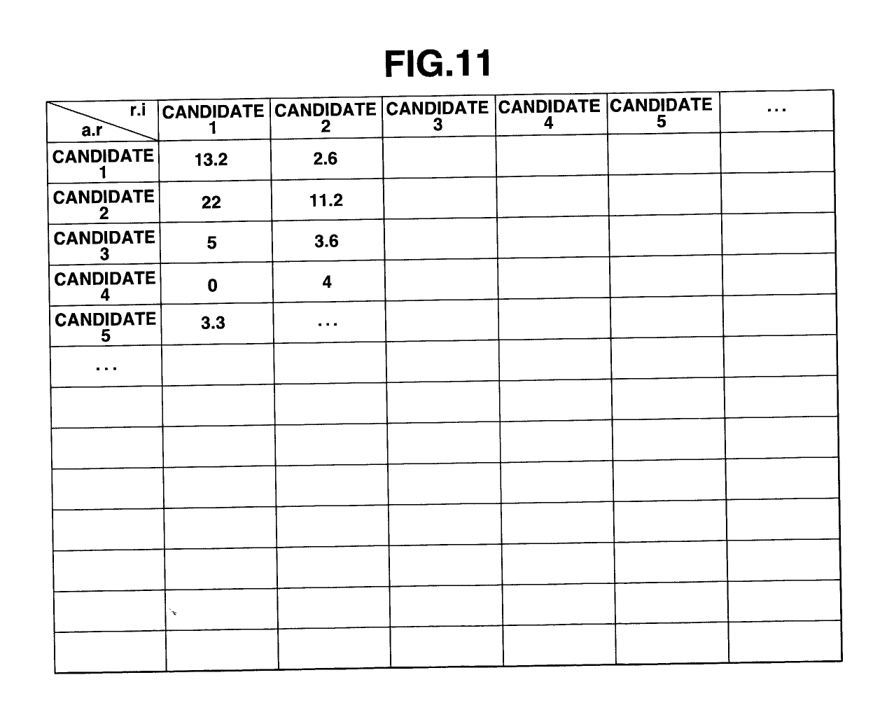

FIG. 11 is a diagram illustrating a table storing concatenation distortions between a diphone “/a.r/” and a diphone “/r.i/”. In FIG. 11, synthesis units of the “/a.r/” are shown on the ordinate, and synthesis units of the “/r.i/” are shown on the abscissa. For example, a concatenation distortion between a synthesis unit “id3” of the “/a.r/” and a synthesis unit “id2” of the “/r.i/” is “3.6”. By preparing all concatenation distortions between connectable diphones in a table as shown in FIG. 11, calculation of concatenation distortions during speech synthesis can be performed only by referring to the table. Hence, it is possible to greatly reduce the amount of calculation, and greatly reduce the time for calculation.

Thirteenth Embodiment

Although in the first embodiment, the case of calculating a modification distortion every time a synthesis unit is modified during speech synthesis has been described, the present invention is no limited to such an approach. For example, modification distortions may be calculated in advance and stored in a table.

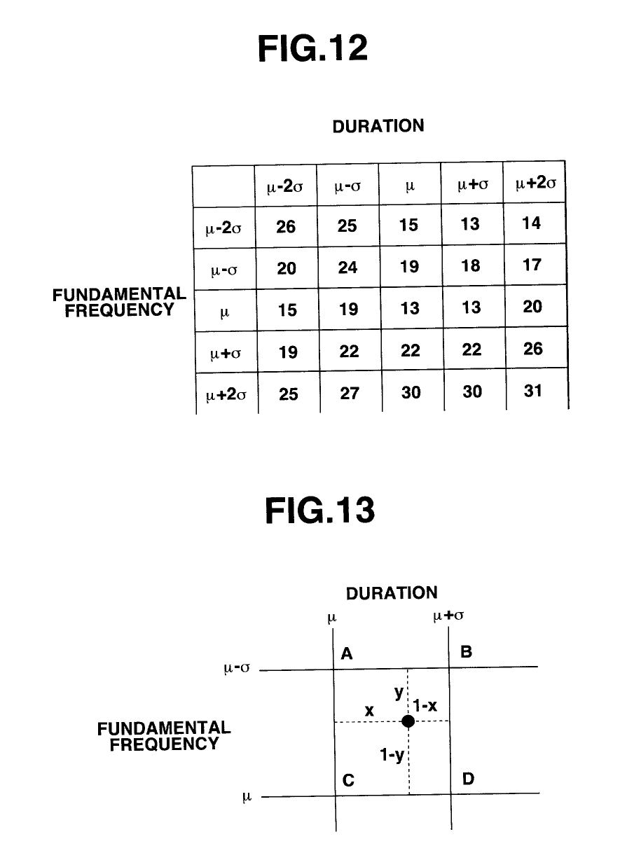

FIG. 12 is a table indicating modification distortions when the fundamental frequency and the duration of a diphone are changed.

In FIG. 12,μ represents a statistical mean value of a diphone, and σ represents a standard variation. More specifically, values in the table are formed according to the following method. First, a mean value and a standard variation are statistically obtained for the fundamental frequency and duration. Then, each modulation distortion may be obtained by applying the PSOLA to each of (5×5=) 25 combinations of the fundamental frequency and duration. During synthesis, if the fundamental frequency and duration are determined, a modification distortion can be estimated by performing interpolation (or extrapolation) using values close to target values in the table.

FIG. 13 is a diagram illustrating a specific example of estimating a modification distortion during synthesis.

In FIG. 13, a black circle represents the target fundamental frequency and duration. If it is assumed that modification distortions at lattice points are obtained as A, B, C and D from the table, a modification distortion Dm can be obtained according to the following equation:

Dm={A·(1−y)+C−y}×(1−x)+{B·(1−y)+D·y}×x.

Fourteenth Embodiment

Although in the above-described thirteenth embodiment, the 5×5 table is formed by providing lattice points of the modification-distortion table based on a statistical mean value and a standard variation of each diphone, the present invention is not limited to such an approach, but a table may have arbitrary lattice points. Alternatively, lattice points may be decisively provided without depending on mean values and the like. For example, a range which can be estimated as a prosody may be equally divided.

Fifteenth Embodiment

Although in the first embodiment, the case of quantifying a distortion using a weighted sum of a concatenation distortion and a modification distortion has been described, the present invention is not limited to such an approach. For example, by setting a threshold for each of a concatenation distortion and a modification distortion, and arranging so that the concerned synthesis unit is not selected when any one of the concatenation distortion and the modification distortion exceeds the threshold, a distortion having a sufficiently large value may be provided.

Although in the foregoing embodiments, the case of providing the respective units in the same computer has been described, the present invention is not limited to such an approach. For example, the respective units may be dispersed in computers, processing apparatuses or the like dispersed on a network.

Although in the foregoing embodiments, the case of holding a program in a control memory (ROM) has been described, the present invention is not limited to such an approach. For example, the operations of each of the embodiments may be realized using an arbitrary storage medium, such as an external storage device or the like, or using a circuit performing the same operations.

The present invention may be applied to a system comprising a plurality of apparatuses, or an apparatus comprising a single unit. The objects of the present invention may also be achieved by supplying a system or an apparatus with a storage medium recording program codes of software for realizing the functions of the above-described embodiments, and reading and executing the program codes stored in the storage medium by means of a computer (or a CPU or an MPU (microprocessor unit)) of the system or the apparatus.

In such a case, the program codes themselves read from the storage medium realize the functions of the above-described embodiments, so that the storage medium storing the program codes constitutes the present invention. For example, a floppy disk, a hard disk, an optical disk, a magnetooptical disk, a CD-ROM, a CD-R (recordable), a magnetic tape, a nonvolatile memory card, a ROM or the like may be used as the storage medium for supplying the program codes.

The present invention may be applied not only to a case in which the functions of the above-described embodiments are realized by executing program codes read by a computer, but also to a case in which an OS (operating system) or the like operating in a computer executes a part or the entirety of actual processing, and the functions of the above-described embodiments are realized by the processing.

The present invention may also be applied to a case in which, after writing program codes read from a storage medium into a memory provided in a function expanding board inserted into a computer or in a function expanding unit connected to the computer, a CPU or the like provided in the function expanding board or the function expanding unit performs a part or the entirety of actual processing, and the functions of the above-described embodiments are realized by the processing.

As described above, according to the foregoing embodiments, since a concatenation distortion and a modification distortion are used as criteria when selecting a synthesis unit in speech synthesis, it is possible to perform speech synthesis by obtaining a synthesis-unit series in which degradation of quality is minimized.

The individual components shown in outline or designated by blocks in the drawings are all well known in the speech signal processing apparatus and method arts and their specific construction and operation are not critical to the operation or the best mode for carrying out the invention.

While the present invention has been described with respect to what are presently considered to be the preferred embodiments, it is to be understood that the invention is not limited to the disclosed embodiments. To the contrary, the present invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. A speech signal processing apparatus for performing speech synthesis by concatenating a plurality of selected synthesis units and modifying the synthesis units based on predetermined prosody parameters, said apparatus comprising:
distortion obtaining means for obtaining a distortion which may be generated from selection to synthesis of the synthesis units;
selection means for selecting synthesis units to be used for speech synthesis, based on the distortion obtained by said distortion obtaining means; and
speech synthesis means for performing speech synthesis based on the synthesis units selected by said selection means.

2. An apparatus according to claim 1, wherein said selection means selects a plurality of synthesis units based on a phoneme series including a plurality of phonemes.

3. An apparatus according to claim 1, wherein said distortion obtaining means obtains a distortion which may be generated in each of a plurality of synthesis units corresponding to one phoneme, and wherein said selection means selects one synthesis unit from among the plurality of synthesis units corresponding to the one phoneme.

4. An apparatus according to claim 1, wherein said selection means selects the synthesis units to be used in speech synthesis so as to minimize the distortion.

5. An apparatus according to claim 1, wherein said distortion obtaining means obtains the distortion based on a concatenation distortion generated by concatenating a synthesis unit to another synthesis unit and a modification distortion generated by modifying the synthesis unit.

6. An apparatus according to claim 1, wherein said distortion obtaining means uses a value obtained by adding a concatenation distortion generated by concatenating a synthesis unit to another synthesis unit and a modification distortion generated by modifying the synthesis unit as the distortion.

7. An apparatus according to claim 3, wherein said distortion obtaining means calculates the distortion as a weighted sum of the concatenation distortion and the modification distortion.

8. An apparatus according to claim 5, wherein said distortion obtaining means calculates the concatenation distortion using a cepstrum distance.

9. An apparatus according to claim 5, wherein said distortion obtaining means calculates the modification distortion using a cepstrum distance.

10. An apparatus according to claim 5, wherein said distortion obtaining means includes a table storing modification distortions, and determines the modification distortion by referring to the table.

11. An apparatus according to claim 5, wherein said distortion obtaining means includes a table storing concatenation distortions, and determines the concatenation distortion by referring to the table.

12. An apparatus according to claim 1, further comprising:
input means for inputting text data;
language analysis means for performing language analysis of the text data; and
prosody-parameter generation means for generating the predetermined prosody parameters based on a result of analysis of said language analysis means.

13. A speech signal processing method comprising:
a distortion obtaining step of obtaining a distortion generated by concatenating a plurality of selected synthesis units and modifying the synthesis units based on predetermined prosody parameters;
a selection step of selecting synthesis units to be used for speech synthesis, based on the distortion obtained in said distortion obtaining step; and
a speech synthesis step of performing speech synthesis based on the synthesis units selected in said selection step.

14. A method according to claim 13, wherein in said selection step, a plurality of synthesis units are selected based on a phoneme series including a plurality of phonemes.

15. A method according to claim 13, wherein in said distortion obtaining step, a distortion which may be generated in each of a plurality of synthesis units corresponding to one phoneme is obtained, and wherein in said selection step, one synthesis unit is selected from among the plurality of synthesis units corresponding to the one phoneme.

16. A method according to claim 13, wherein in said selection step, the synthesis units to be used in speech synthesis are selected so as to minimize the distortion.

17. A method according to claim 13, wherein said distortion obtaining means obtains the distortion based on a concatenation distortion generated by concatenating a synthesis unit to another synthesis unit and a modification distortion generated by modifying the synthesis unit.

18. A method according to claim 13, wherein in said distortion obtaining step, a value obtained by adding a concatenation distortion generated by concatenating a synthesis unit to another synthesis unit and a modification distortion generated by modifying the synthesis unit is used as the distortion.

19. A method according to claim 17, wherein in said distortion obtaining step, the distortion is calculated as a weighted sum of the concatenation distortion and the modification distortion.

20. A method according to claim 17, wherein in said distortion obtaining step, the concatenation distortion is calculated using a cepstrum distance.

21. A method according to claim 17, wherein in said distortion obtaining step, the modification distortion is calculated using a cepstrum distance.

22. A method according to claim 17, wherein in said distortion obtaining step, a table storing modification distortions is provided, and the modification distortion is determined by referring to the table.

23. A method according to claim 17, wherein in said distortion obtaining step, a table storing concatenation distortions is provided, and the concatenation distortion is determined by referring to the table.

24. A method according to claim 13, further comprising:
an input step of inputting text data;
a language analysis step of performing language analysis of the text data; and
a prosody-parameter generation step of generating the predetermined prosody parameters based on a result of analysis in said language analysis step.

25. A storage medium, capable of being read by a computer, storing a program for executing a method according to any one of claims 13 through 24.
